(19) United States
(12) Patent Application Publication
(10) Pub. No.: US 2008/0152354 A1
(43) Pub. Date: Jun. 26, 2008

(54) Fiber Optically Coupled Control System for Homes and Businesses

(76) Inventor: James L. Busby, Mobile, AL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/615,443

(22) Filed: Dec. 22, 2006

(51) Int. Cl. H04B 10/04

(52) U.S. Cl. 398/164

(57) ABSTRACT

A control circuit linking individual wall boxes within a structure with a master control unit maintains electrical isolation between the control circuit and the circuit to be controlled by means of a fiber optic interface at each wall box which is to be controlled. Each such wall box contains a control circuit having an optical receiver for converting optical impulses to control signals. Each interface includes an optical transmitter for converting electrical control signals to optical impulses. A fiber optic connection between the interface and the control circuit passes through the wall box to provide control communications.

### BACKGROUND OF THE INVENTION

Structured wiring has become commonplace in residential and industrial buildings. Structured wiring as used herein means pre-wiring and centralizing wiring such that changes, additions to and troubleshooting of the electronic infrastructure of the building will be greatly simplified. Wall switch boxes generally contain either high voltage wiring or low voltage wiring, but according to the National Electrical Code, they cannot ordinarily simultaneously contain both. Wall box dimmers for example can be interconnected using normal high voltage (115 v) house wiring, but cannot be connected together using CAT-5 communications cable because the CAT-5 cable cannot be placed inside the wall switch box. Radio frequency receivers and transmitters can be utilized to interconnect the units, but are subject to range limitations, frequency interference, and many other potential reliability issues. Centralized dimming systems are available, but they require a completely different wiring scheme from conventional wiring.

It would be beneficial for condominium or other multi-unit developers to be able to pre-wire wall switch boxes using CAT-5 communications cable at the high voltage switch box locations. This is not possible because of the NEC rule barring low and high voltage circuits entering the same wall box. The present invention provides a method and apparatus to provide low voltage control of high voltage equipment without violating any rules or safety codes. It allows pre-wiring of CAT-5 cable at all high voltage locations so that control signals from a centralized controller can be brought into that box without the need for an electrical conductor. Thus, the cost of the equipment can be passed on to the end-user as an optional feature without the need for the builder/developer to pay for the total equipment cost.

### OBJECTS OF THE INVENTION

The principal object of this invention is to eliminate the problem associated with using high and low voltage in the same wall box in order to control the fixtures, appliances or equipment associated with the wall box. Another object of the invention is to provide the capability of having the control system completely hard-wired to provide a system that is inherently extremely reliable. Yet another object of the invention is to improve the resistance of household control circuits to lightning and static discharge.

### SUMMARY OF THE INVENTION

A structure is pre-wired by running a standard communications cable, for example CAT-5 or equivalent cable from a central location to each location which may be later controlled. The wire is secured to the outside of the “rough-in” box by one or more attachment means. A length of the wire is then pulled inside the box so that a “smart bubble” may be later installed at that point in the cable. When the structure is finished, the owner may elect to place a device such as a wall box dimmer, fan speed controller, audio system controller, intercom, security panel, or other device at each location, or, he/she may decide to simply push the low voltage wire back out of the box into the wall and install a conventional switch/device. If a device controller is to be installed, then an electrical to optical converter or smart bubble is installed externally to the wall box and a non-conductive optical fiber is connected between the smart bubble and an optical to electrical converter inside the box connected to a control device for the structural wiring for the wall box.

### BRIEF DESCRIPTION OF THE DRAWINGS

The embodiments of the present invention are depicted in the appended drawings which form a portion of this disclosure and wherein:

FIG. 1 is a diagrammatic layout of the master control unit, low voltage cable, smart bubbles and wall boxes;

FIG. 2 is a second diagrammatic layout of the master control unit, low voltage cable, smart bubbles in a different configuration;

FIG. 3 is a side elevational view of a framed in wall with a wall box attached to a stud and a low voltage cable connected to the wall box;

FIG. 4 is a side elevational view of the smart bubble attached to the low voltage cable externally of the wall box with optical fibers entering the wall box;

FIG. 4a is a perspective view of a door with optical fibers passing through the door.

FIG. 5 is a diagrammatic view of the smart bubble.

FIG. 6 is schematic view of one embodiment of the smart bubble.

FIG. 7 is a diagrammatic view of a T connection to the control cable for attaching a smart bubble.

### DESCRIPTION OF THE PREFERRED EMBODIMENTS

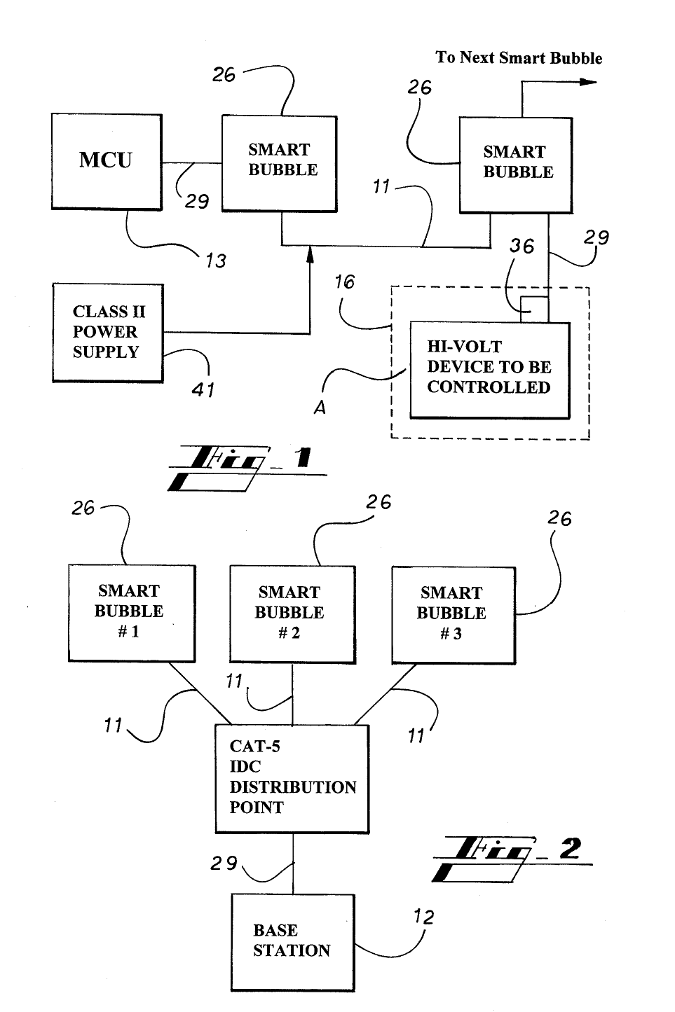

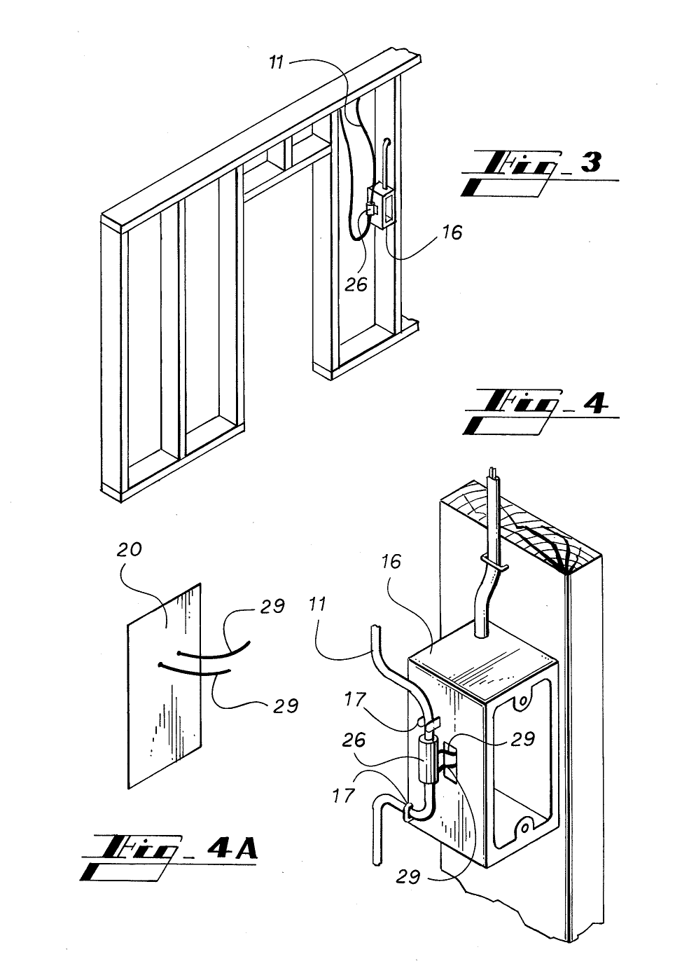

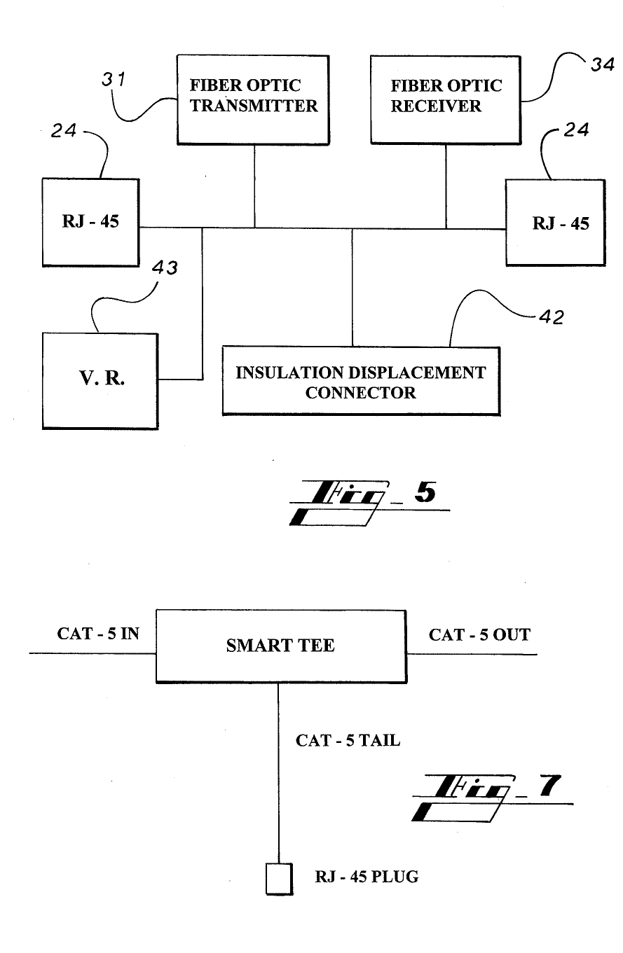

Referring to the drawings for a clearer understanding of the invention it may be seen from FIG. 1, that the present invention is intended for preliminary installation during the construction of a dwelling or other structure. During the pre-wire (rough-in), low voltage communications cable 11 (Cat-5 or equivalent) is started at the proposed location of the base station or Master Control Unit 12 (MCU), and then strung to each control enclosure, for example a wall box 16 where control may be added to a controllable appliance A in the future. The wiring may be a loop as shown FIG. 1, or a hub and spoke arrangement as shown in FIG. 2. As may be seen in FIG. 3, two molded in flanges 14 with specially designed slots and hooks 17 serve as retention members used to secure the cable 11 to the outside of the wall box 16. It is to be understood that various other configurations including L shaped flanges, lugs, ears, clips, set screws, tabs or any other molded point of attachment may be used to secure cable 11 without departing from the scope of the invention. A loop 18 of the cable may be passed inside wall box 16 through an aperture which will, at trim-out time be sealed. The cable loop 18 is curled up in the box and remains until trim out time.

At trim out time (Europeans call it the “final fixing”) a decision is made for each wall box 16 whether to trim it out with controlled or conventional devices. If conventional devices are to be installed at any given wall box location, then the CAT-5 wire is not needed. It is simply pushed back out into the wall and a door 20 covering the aperture in the wall box is installed.

If the owner wishes to be able to control the high voltage device located in the wall box 16 then it will be necessary to “trim out” the cable 11 to add a high voltage device. To trim out cable 11 at a wall box 16, cable loop 18 inside wall box 16 can be cut creating two “free” ends 21 and 22. The free ends 21, 22 are each fitted with a RJ-45 CAT-5 cable plug 23. The cable plug 23 fits into a CAT-5 cable socket 24 on a “smart bubble” 26. The “smart bubble includes a circuit board 27 connected to two RJ-45 CAT-5 cable sockets 24 and one or more fiber optic cable connectors 28 associated with an optical transmitter 31 and receiver 34 included on circuit board 27. The basic optical transmitter converts electrical input signals from MCU 12 into modulated light for transmission over an optical fiber. Depending on the nature of this signal, the resulting modulated light may be turned on and off corresponding to a digital signal or may be linearly varied in intensity between two predetermined levels. Typically a light emitting diode or laser diode is used as the light source in an optical transmitter. Fiber optic connectors 28 are connected to optical fiber 29. When the free ends 21, 22 of cable 11 are connected to the smart bubble 26, the bubble 26 and the cable ends 21, 22 are pushed through the aperture 16 with the optical fiber 29 connected to smart bubble 26 extending through an aperture into the wall box. The smart bubble is powered by the low voltage carried by the CAT-5 cable 11 and regulated by voltage regulator 43 on circuit board 27.

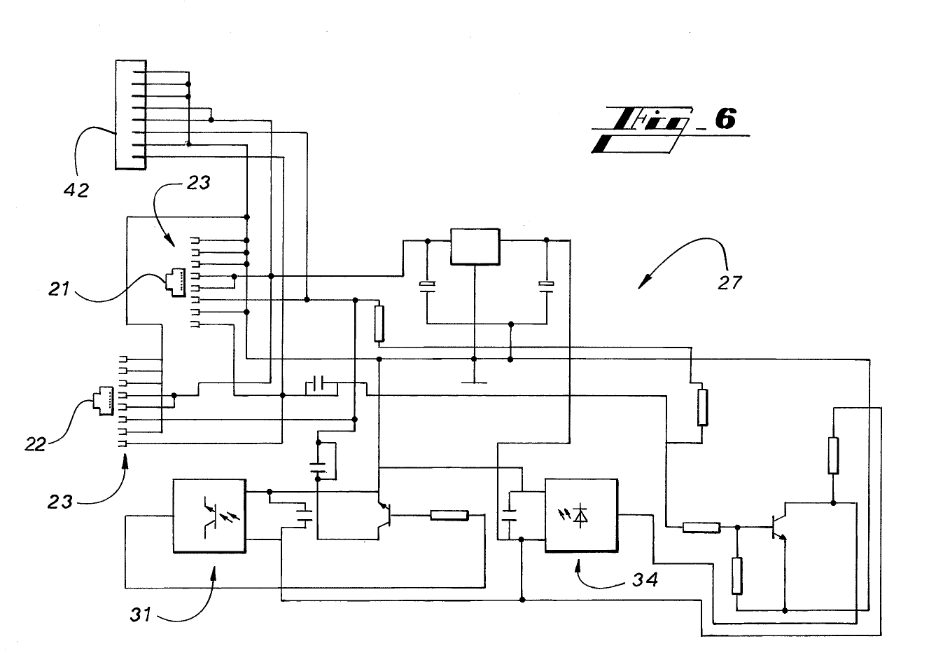

Alternatively, as shown in FIG. 6, the smart bubble 26 may be configured with an insulation displacement connector 42 and the control cable does not need to be cut to connect the smart bubble to the control line. Specifically, the 8 pin insulation displacement connector 42, has pin 1 connected to the optical transmitter 31 and pin 3 connected to the optical transmitter. This connection is common with pins 1 and 3 of the RJ-45 connectors mounted on the smart bubble board, thus any digital information passed along the cat 5 cable is similarly used by the smart bubble regardless of whether the connection is made by RJ-45 connections or an IDC.

The optical fiber 29 attaches to the controlled equipment 32, which may be an on/off switch, a three position switch, a dimmer, or any other such equipment. Controlled equipment 32 has an associated control circuit 36 mounted inside wall box 16. As seen in FIG. 7, control circuit 36 utilizes a matching fiber optic connector 33 associated with an optical receiver 34 which converts the modulated light coming from the optical fiber 29 back into a replica of the original electrical signal applied to the transmitter 31. The detector of this modulated light is usually a photodiode with electrical outputs to control circuit 36 which draws power from the high voltage line inside the wall box 16. Photodiodes usually have a large sensitive detecting area that can be several hundred microns in diameter. This relaxes the need for special precautions in centering the fiber in the receiving connector and makes the “alignment” concern much less critical than it is in optical transmitters. Thus the use of optical fiber connections is easily accomplished and the resultant separation of up to several inches of optical fiber between the transmitter and receiver effectively isolates the low voltage system from the AC system. Thus it may be seen that the CAT-5 control cable 11 is electrically isolated from the appliance power source and is not inside the wall box 16. That is to say, the optical fiber 29 is the only connection between the CAT-5 cable with its smart bubble 26 externally of wall box 16 and the 115/120 volt equipment inside the wall box 16. The digital signals are applied to the resident logic components 55 in control circuit 36 which can discriminate as to which digital signals sent by the MCU are intended for the equipment That is to say, each device to be controlled by the circuit can be digitally identified and the digital identification can be used by the resident logic circuit to determine which signals sent by the MCU are intended for the specific associated device.

The present invention thus represents a significant improvement over the invention described in U.S. Pat. No. 6,297,724 which described the use of opto-couplers which did not provide true electrical isolation between a low voltage control circuit and the AC circuit powering the controlled equipment. It should be noted that hard wired systems, including the one shown in the '724 patent are somewhat prone to lightning damage because of electrically conductive connections between devices. In opto-couplers as described in the '724 patent the physical and electrical separation between components fails to protect against higher voltage due to the close proximity of the components. In other words, the '724 device has both low and high voltage on the same board and is not acceptable for use in the applications contemplated by the present invention. The present system isolates all units from each other by means of electrically non-conductive optical fiber. It also eliminates the possibility of a low voltage copper wire becoming high-voltage live by coming into contact with a live AC circuit.

The last location on the low voltage cable 11 must have a “terminator plug” 36 installed in the open end of the “smart bubble” 26. The “terminator plug” consists of a circuit board, an RJ-45 plug, and other electronic components which are necessary for proper reliable transmission of data down the cable.

During installation, cable 11 should (but not absolutely necessary) be looped all the way back to the origination point if possible. By doing so, even if the cable is accidentally broken or cut at any point in the middle, a complete connection can be made to all the devices by starting at one end and placing a terminator plug 36 at the last good cable location. Alternatively, as shown in FIG. 2 diverse wiring patterns such as a hub and spoke configuration may be suitable for use in many applications and can be used where the low voltage line is appropriately resistively terminated as is well known in the art.

In one embodiment of the system, all data connections including the connection from the MCU 12 to the cable 11 are made using optic fiber as shown in FIGS. 1 and 2. That is to say the MCU has an optical transmitter 31 and an optical receiver 34 connected to optical fibers connected to a smart bubble 26 on communications cable 11. A transformer type AC to DC power supply 41 can be used to provide power to the “smart bubbles” in the cable, but the power supply 41 is only directly connected to cable itself 11 by the transformer windings. Therefore the system should be highly lightning resistant and nearly lightning proof.

It should also be noted that in a wall box 16 having multiple switches or control devices, each control circuit can be connected to a separate smart bubble by optical fiber, however, this is not necessary for isolation of the control cable 11 in as much a single optical fiber connection can carry the control signals for each switch. In this embodiment, the optical fiber is connected to a control circuit 36 associated with one of the controlled equipment 31 in the wall box and the signals to the other controlled equipment in the box, if any, can be transmitted over low voltage electrical connections to their associated control circuits 36. It will be appreciated that each switch, dimmer or other device will be uniquely identified in the system such that the MCU can selectively communicate with each such unit. Thus, the circuitry on each smart bubble may have resident logic components which can discriminate as to which digital signals sent by the MCU are intended for the equipment that is optically connected to that smart bubble and which will activate the optical transmitter only when it identifies a signal intended for the associated equipment. Alternatively, the circuitry inside the wall box includes resident logic which can accept or pass the signal to other devices inside the wall box, and in such circumstances the smart bubble does not need the resident logic to determine which signals to pass. In some instances, the smart bubble 26 and the low voltage control circuit inside the wall box will have both optical transmitters and receivers such that reply signals can be sent from the controlled equipment to the MCU 12 as needed. In the foregoing example, a wall box 16 may include three control elements such as two position switches controlling different lighting elements. Each switch may have an associated control circuit associated therewith. In the present invention each control circuit 36 would be uniquely digitally identified such that the MCU 12 could send control signals to the circuit to control the operation of the switch. The smart bubble 26 adjacent wall box 16 would have fiber optic connection to one of the control circuits 36 a inside the box, and that control circuit would have low voltage connection to each other control circuit such that the digital signals transmitted optically to the one control circuit could be relayed to the other control circuits 36b and c. Since each circuit is digitally identified, the logic on each circuit is responsive only to signals including its digital identifier. Likewise the smart bubble may be configured to optically pass the digital information only to the control circuits 36 with which it is in optical communication, passing non-associated digital commands along the communications cable 11 in uninterrupted fashion.

In another embodiment of the invention, shown in FIG. 8, the control cable 111 is not cut at the wall box. Rather at each selected wall box, the cable has shorter Cat 5 cable spliced and terminated with an RJ-45 connector on its free end. The RJ-45 connection is snap fit into a non conductive rj-45 holder on removable door 20 covering the aperture in wall box 16. Thus, to install the smart bubble the door is removed, and discarded and a door 20′ including optical fibers is used to replace it. The smart bubble is connected to the shorter cat 5 cable via the RJ45 connection and to the controlled element using the fiber optics passing through the replacement door.

While the present invention has been described with reference to multiple embodiments, it is not so limited and the embodiments described are for purposes of illustration, it being understood that the invention is limited only by the scope of the appended claims.

What I claim is:

1. In structure having an electrical system supplying AC power to a plurality of electrical devices each having separate control elements located within an enclosure, wherein, a low voltage control cable is provided externally of said enclosure to transmit control signals intended for said control elements, the improvement comprising:
a. a device control circuit, having an optical receiver, operating at a low voltage derived from said electrical system and associated with each control element to be actuated and located within an enclosure enclosing said associated control element;
b. at least one interface element, including an electrical to optical transmitter connected to said low voltage control cable externally of said enclosure, and receiving power from said low voltage control circuit;
c. at least one optic fiber connected between said optical transmitter and said optical receiver.

2. The improvement as described in claim 1 further comprising a master control unit including a programmable circuit having an output to said low voltage control circuit to control each device control circuit.

3. The improvement as described in claim 2 further comprising a master control unit interface element connected to said low voltage circuit and at least one optic fiber connected between said master control unit interface element and said master control unit.

4. The improvement as described in claim 1 further comprising an enclosure for enclosing an electrical component of said AC electrical system within the wall of a structure, said enclosure having an aperture therein and at least one external retention member engaging said control cable.

5. The improvement as defined in claim 1 wherein said interface element and said device control circuit each have optical transmitter and receiver components such that optical data can be sent and received thereby.

6. The improvement as defined in claim 2 wherein each device control circuit includes an addressable memory containing a unique identifier such that said master control unit can transmit a control message to said circuit.

7. The improvement as defined in claim 2 wherein said interface element includes an addressable storage device containing a unique identifier for one or more control elements associated with said interface element, whereby said interface element receives all signals sent by said master control unit but transmits only signals intended for said associated control elements to said elements.

8. The improvement as defined in claim 1 wherein said at least one optical fiber extends through an aperture in said enclosure.

9. The improvement as defined in claim 1 wherein said at least one optical fiber extends through said enclosure.

10. A method for controlling line voltage devices within a structure wherein said line voltage devices have control elements mounted in enclosures, comprising the steps of:
a. providing a master control unit at a designated location for controlling line voltage devices within an area of said structure;
b. providing a low voltage cable within the internal walls of said structure said cable connected to said master control unit and proximal said enclosures containing control elements;
c. attaching said low voltage cable to said enclosures, and inserting a portion of said low voltage cable into said enclosure through an aperture therein;
d. selecting the line voltage devices to be controlled by said master control unit;
e. urging said low voltage cable out of said enclosures of all control boxes not associated with selected line voltage devices;
f. connecting an interface element to said low voltage cable,
g. connecting said interface element to said control element with at least one optical fiber to provide data transmission with electrical isolation between said control element and said low voltage cable;
h. sending electronic instructions from said Master control unit to any of said control elements via an interface element connected thereto by at least one optical fiber.

11. The method as defined in claim 10 further comprising the steps of: providing a master control interface element connected to said low voltage cable proximal said master control unit; and, interfacing said master control interface element to said master control unit with at least one optical fiber to provide data transmission with electrical isolation between said master control unit and said low voltage cable;

12. The method as defined in claim 10 wherein said connecting step comprises:
affixing at least one optical fiber on an optical transmitter on said interface element, positioning said interface element externally of said enclosure, affixing said at least one optical fiber to an optical receiver internally of said enclosure.
